(19) United States
(12) Patent Application Publication
(10) Pub. No.: US 2010/0049560 A1
(43) Pub. Date: Feb. 25, 2010

(54) RETENTION OF SUBSCRIBERS TO A COMMUNICATION SERVICE

(75) Inventor: John M. Harris, Glenview, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/196,314

(22) Filed: Aug. 22, 2008

(51) Int. Cl. G06F 17/00; G06Q 30/00

(52) U.S. Cl. 705/7; 705/14.73

(57) ABSTRACT

An apparatus and method to retain subscribers to a communication service includes a first step (100) of defining at least one retention limit for a subscriber. A next step (102) includes estimating a communication parameter for the subscriber. A next step (104) includes comparing the communication parameter against the retention limit. A next step (106) includes improving a communication experience for the subscriber in response to the comparison of the estimated communication parameter and the retention limit.

### FIELD OF THE INVENTION

This invention relates to communication services, and in particular, to a technique for retaining subscribers to a communication service.

### BACKGROUND OF THE INVENTION

At present communication service providers are experiencing problems retaining customers after their service contracts expire, wherein a subscriber will switch to a new service provider. Such so called “chum” is not cost effective for service providers, while also being inconvenient to subscribers.

Some of the top priorities for service providers include having satisfied customers, receiving revenue through other (non-transport) revenue streams, and reducing chum, i.e. avoid people switching operators when their contract expires. Operators recognize these problems and need to take advantage of opportunities to make improvements in these top priorities.

One of the problems to be addressed is having satisfied customers. One of the biggest complaints of users is poor communication service, such as dropped calls. Cellular systems often fail due to dropped calls, which is frustrating to users. Another satisfaction problem is unexpected costs associated with a communication service, such as roaming charges, exceeding (prepaid) minutes or bytes, text charges, or data charges.

Another problem to be addressed is increasing revenue received through other (non-transport) streams. For example, service providers have found that revenue can be increased by selling ring tones to users, or receiving payments for providing advertising to users. Of course, users are reluctant to pay excessive amounts for ring tones or receive too much advertising.

What is needed is a technique to retain subscribers to a particular communication service.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 shows a block diagram of a system, in accordance with the present invention; and

FIG. 2 shows a flow chart illustrating a method, in accordance with the present invention.

Skilled artisans will appreciate that common but well-understood elements that are useful or necessary in a commercially feasible embodiment are typically not depicted or described in order to facilitate a less obstructed view of these various embodiments of the present invention.

### DESCRIPTION OF THE PREFERRED EMBODIMENTS

The present invention provides several techniques to retain subscribers to a particular communication service. The present invention, addresses top operator priorities including users who experience; dropped calls, roaming charges or extended minutes/bytes, at the end of their service contract, poor service.

For example, for users who experience poor service such as dropped calls, the present invention will provide users with better than average Quality of Service (QoS) in future communications, fewer unsolicited advertisements, etc. The number of dropped calls or poor service can be monitored directly through the communication system, or can be determined indirectly through voice analysis of subscribers. For example, technology presently exists to have processors in a server or in the subscriber device automatically identify users on calls who are frustrated, upset, or aggravated, such as are used when monitoring a help desk phone line. Upon recognition of this problem, users will receive particular good QoS under the assumption that subset of the calls are particularly important to the user.

For users experience higher costs, such as roaming charges or using minute/bytes beyond their prepaid costs, which generates more revenue per resource, such users can be rewarded when using even more minutes by receiving an even better user experience through higher QoS (e.g. higher vocoder bit rate/resolution, more frequent presence or e-mail updates), better/more content, lower cost content, fewer advertisements, etc.

For users nearing the end of their service contract, such users can be encouraged to renew their service contract by receiving a particularly good user experience through higher QoS, better/more content, lower cost content, fewer advertisements, etc.

It is envisioned that portions of the present invention can be implemented within; the cellular infrastructure, application enablers within a network, application servers, or even within the client device.

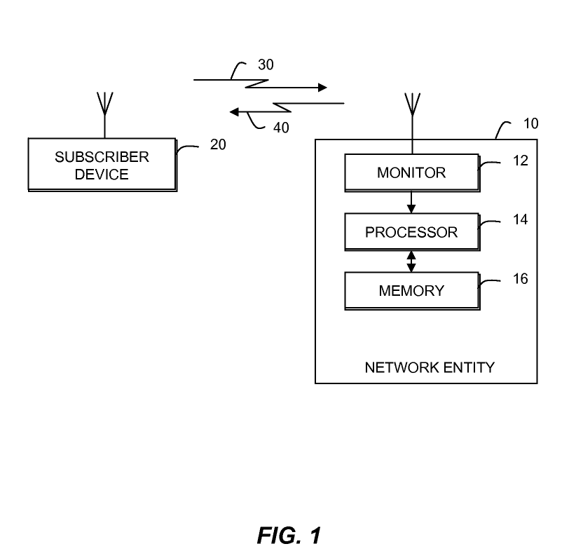

FIG. 1 shows a block diagram of a portion of a communication network, in accordance with the present invention. The communication network can support one or more of voice, text and data services over either wireless or wireline connections. As shown in the example of FIG. 1, the communication network includes a subscriber device 20, such as a mobile radiotelephone, personal digital assistant, computer, or any other communication device. The network also includes a network entity 10, such as can be found in cellular infrastructure (e.g. base stations, network controllers, and the like), application enablers within a network, application servers, or any other type of element that provide communication services. In accordance with the present invention, the network entity 10 can even be the subscriber device itself 20. Although the network entity is shown communicating with the subscriber device wirelessly 30, 40, the present invention is also applicable to wireline systems, such as internet, cable, or telephone line connections, for example,

The network entity includes a monitor function 12, a processor function 14, and a memory 16. In accordance with the present invention, the memory 16 is operable to hold a defined list of at least one retention limit for a subscriber. The retention limits can be defined in the network entity or can be supplied to the network entity by the network service provider. The retention limit is associated with particular communication parameters, as will be explained below. The communication monitor 12 is operable to estimate a communication parameter for the subscriber. The monitor can simply be a receiver that detects conditions for a channel signal 30 (e.g. a dropped call, low QoS, or high error rate) or can be a software application that automatically monitors a subscriber's voice (i.e. to detect a stress level in the voice). Additionally the monitor 12 can be a customer service representative on a call with a subscriber, where the customer service representative provides a manual entry for the processor indicating a subscriber's particular dissatisfaction with some aspect of the service being provided to the subscriber. The processor 14 is coupled to the memory 16 and the monitor 12, and is operable to compare a communication parameter against the associated retention limit, wherein the processor is operable to then improve a communication experience for the subscriber in response to the comparison of the estimated communication parameter and the retention limit. The improved communication experience can be provided for subsequent calls or even an ongoing call 40.

Examples of improved communication experiences can include; a) a reduction in the amount of advertising sent to the subscriber, b) an increase in content per cost for the subscriber, such as providing premium content for free or a reduce cost, c) improved service (e.g. QoS) for communications, and/or d) more frequent presence or e-mail updates for a subscriber device.

Specifically, it is envisioned that wherein the retention limit is a cost/service limit for the subscriber and the communication parameter is an amount of cost/service used by the subscriber, the processor 14 invokes the improved communication experience 40 if the amount of cost/service used by the subscriber exceeds the cost/service limit, respectively.

In one embodiment, the retention limit is a service limit for the subscriber and the communication parameter is an amount of service used by the subscriber, wherein the processor 14 invokes the improved communication experience 40 if the amount of service used by the subscriber exceeds the service limit.

In another embodiment, the retention limit is a stress limit and the communication parameter is an amount of stress estimated for the subscriber, wherein the processor 14 invokes the improved communication experience 40 if the amount of stress of the subscriber exceeds the stress limit.

In another embodiment, the retention limit is a predetermined date before the service contract termination date for the subscriber and the communication parameter is a number of days into the service contract for the subscriber, wherein the processor 14 invokes the improved communication experience 40 if the number of days into the service contract exceeds the predetermined date before the service contract termination date.

In another embodiment, the retention limit is a predetermined limit for dropped calls for the subscriber and the communication parameter is a number of dropped calls for the subscriber, wherein the processor 14 invokes the improved communication experience 40 if the number of dropped calls for the subscriber exceeds the predetermined limit for dropped calls for the subscriber.

In another embodiment, the retention limit is a predetermined limit for roaming minutes for the subscriber and the communication parameter is a number of roaming minutes for the subscriber, wherein the processor 14 invokes the improved communication experience 40 if the number of roaming minutes for the subscriber exceeds the predetermined limit for roaming minutes for the subscriber.

In another embodiment, the retention limit is a predetermined cost limit for the subscriber and the communication parameter is a cost for the subscriber, wherein the processor 14 invokes the improved communication experience 40 if the cost for the subscriber exceeds the predetermined cost limit for the subscriber.

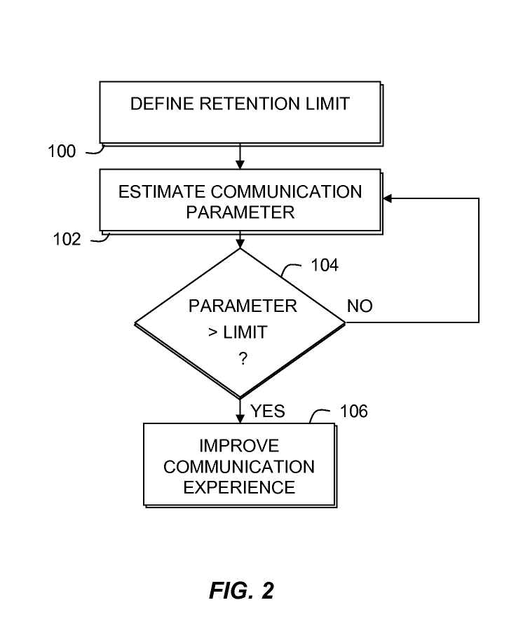

It should be recognized that any of the above embodiments of can be used to address any of the previously described communication experiences, e.g. reduced advertising for too many dropped calls, or any other combination. FIG. 2 shows a flowchart that illustrates a method to retain subscribers to a communication service, in accordance with the present invention.

A first step 100 includes defining at least one retention limit for a subscriber. The limit can be predefined and static, or can be dynamically altered during a subscription. Retention limits can include cost/service limits, such as a service limit (e.g. monthly minutes), a stress, upset, or aggravation limit, a date close to a contract termination date, a dropped call limit, a roaming minute limit, a prepaid cost limit, and the like.

A next step 102 includes estimating a communication parameter for the subscriber. The communication parameter can include an amount of service used by the subscriber, an amount of stress estimated for the subscriber, a number of days into the service contract for the subscriber, a number of dropped calls for the subscriber, a number of roaming minutes for the subscriber, a cost for the subscriber, and the like.

A next step 104 includes comparing the communication parameter against the retention limit. For example, if the estimated communication parameter exceeds the retention limit, then the method proceeds with the next step 106. Otherwise, the method returns to the estimating step 102.

A next step 106 includes improving a communication experience for the subscriber in response to the comparison of the estimated communication parameter and the retention limit. The improved communication experience can be provided for subsequent calls or even an existing call. For example, this step can include improving a communication experience for the subscriber if the estimated communication parameter exceeds the retention limit. In particular, the communication experience of this step can be a reduction in cost or improvement in service (e.g. QoS) for the subscriber. Examples of improved communication experiences can include; a) a reduction in the amount of advertising sent to the subscriber, b) an increase in content per cost for the subscriber, such as providing premium content for free or a reduce cost, c) improved service (e.g. QoS) for communications, and/or d) more frequent presence or e-mail updates for a subscriber device.

Specifically, it is envisioned that wherein the retention limit is a cost/service limit for the subscriber and the communication parameter is an amount of cost/service used by the subscriber, the improving step is invoked if the amount of cost/service used by the subscriber exceeds the cost/service limit, respectively.

In one embodiment, the retention limit is a service limit for the subscriber and the communication parameter is an amount of service used by the subscriber, wherein the improving step is invoked if the amount of service used by the subscriber exceeds the service limit.

In another embodiment, the retention limit is a stress limit and the communication parameter is an amount of stress estimated for the subscriber, wherein the improving step is invoked if the amount of stress of the subscriber exceeds the stress limit.

In another embodiment, the retention limit is a predetermined date before the service contract termination date for the subscriber and the communication parameter is a number of days into the service contract for the subscriber, wherein the improving step is invoked if the number of days into the service contract exceeds the predetermined date before the service contract termination date.

In another embodiment, the retention limit is a predetermined limit for dropped calls for the subscriber and the communication parameter is a number of dropped calls for the subscriber, wherein the improving step is invoked if the number of dropped calls for the subscriber exceeds the predetermined limit for dropped calls for the subscriber.

In another embodiment, the retention limit is a predetermined limit for roaming minutes for the subscriber and the communication parameter is a number of roaming minutes for the subscriber, wherein the improving step is invoked if the number of roaming minutes for the subscriber exceeds the predetermined limit for roaming minutes for the subscriber.

In another embodiment, the retention limit is a predetermined cost limit for the subscriber and the communication parameter is a cost for the subscriber, wherein the improving step is invoked if the cost for the subscriber exceeds the predetermined cost limit for the subscriber.

It should be recognized that any of the above embodiments can be used to address any of the previously described communication experiences, e.g. reduced advertising for too many dropped calls, or any other combination. Advantageously, the present invention making the subscriber that much more likely to re-subscribe to the service provider.

It will be understood that the terms and expressions used herein have the ordinary meaning as is accorded to such terms and expressions by persons skilled in the field of the invention as set forth above except where specific meanings have otherwise been set forth herein.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method to retain subscribers to a communication service, the method comprising the step of:
defining at least one retention limit for a subscriber;
estimating a communication parameter for the subscriber;
comparing the communication parameter against the retention limit; and
improving a communication experience for the subscriber in response to the comparison of the estimated communication parameter and the retention limit.

2. The method of claim 1, wherein the communication experience of the improving step is a reduction in the amount of advertising sent to the subscriber.

3. The method of claim 1, wherein the communication experience of the improving step is an increase in content per cost for the subscriber.

4. The method of claim 1, wherein the communication experience of the improving step is an improved Quality of Service for a subscriber device.

5. The method of claim 1, wherein the communication experience of the improving step is more frequent presence updates for a subscriber device.

6. The method of claim 1, wherein the communication experience of the improving step is more frequent e-mail updates for a subscriber device.

7. The method of claim 1, wherein the retention limit is a service limit for the subscriber and the communication parameter is an amount of service used by the subscriber, wherein the improving step is invoked if the amount of service used by the subscriber exceeds the service limit.

8. The method of claim 1, wherein the retention limit is a stress limit and the communication parameter is an amount of stress estimated for the subscriber, wherein the improving step is invoked if the amount of stress of the subscriber exceeds the stress limit.

9. The method of claim 1, wherein the retention limit is a predetermined date before the service contract termination date for the subscriber and the communication parameter is a number of days into the service contract for the subscriber, wherein the improving step is invoked if the number of days into the service contract exceeds the predetermined date before the service contract termination date.

10. The method of claim 1, wherein the retention limit is a predetermined limit for dropped calls for the subscriber and the communication parameter is a number of dropped calls for the subscriber, wherein the improving step is invoked if the number of dropped calls for the subscriber exceeds the predetermined limit for dropped calls for the subscriber.

11. The method of claim 1, wherein the retention limit is a predetermined limit for roaming minutes for the subscriber and the communication parameter is a number of roaming minutes for the subscriber, wherein the improving step is invoked if the number of roaming minutes for the subscriber exceeds the predetermined limit for roaming minutes for the subscriber.

12. The method of claim 1, wherein the retention limit is a predetermined cost limit for the subscriber and the communication parameter is a cost for the subscriber, wherein the improving step is invoked if the cost for the subscriber exceeds the predetermined cost limit for the subscriber.

13. A method to retain subscribers to a communication service, the method comprising the step of:
defining at least one retention limit for a subscriber, each retention limit associated with a communication parameter;
estimating a communication parameter for the subscriber;
comparing the communication parameter against the associated retention limit; and
improving a communication experience for the subscriber if the estimated communication parameter exceeds the retention limit.

14. The method of claim 13, wherein the communication experience of the improving step is a reduction in cost for the subscriber.

15. The method of claim 13, wherein the communication experience of the improving step is an improved Quality of Service for a subscriber device.

16. The method of claim 13, wherein the retention limit is a service limit for the subscriber and the communication parameter is an amount of service used by the subscriber, wherein the improving step is invoked if the amount of service used by the subscriber exceeds the service limit.

17. The method of claim 13, wherein the retention limit is a cost limit for the subscriber and the communication parameter is a cost for the subscriber, wherein the improving step is invoked if the cost for the subscriber exceeds the cost limit for the subscriber.

18. A network entity for retaining a subscriber to a communication service, the network entity comprising:
a memory for holding a defined list of at least one retention limit for a subscriber;
a communication monitor for estimating a communication parameter for the subscriber; and
a processor coupled to the memory and monitor, the processor for comparing the communication parameter against the retention limit, wherein the processor is operable to improve a communication experience for the subscriber in response to the comparison of the estimated communication parameter and the retention limit.
